(19) United States
(12) Patent Application Publication
(10) Pub. No.: US 2015/0356644 A1
(43) Pub. Date: Dec. 10, 2015

(54) Consumer Feedback and Incentive Method and System

(71) Applicant: Nicholas Diana, Portsmouth, NH (US)

(72) Inventor: Nicholas Diana, Portsmouth, NH (US)

(21) Appl. No.: 14/736,204

(22) Filed: Jun. 10, 2015

Related U.S. Application Data
(60) Provisional application No. 62/010,362, filed on Jun. 10, 2014.

(51) Int. Cl. G06Q 30/02; H04W 4/02

(52) U.S. Cl. CPC G06Q 30/0282; H04W 4/02

(57) ABSTRACT

A system and methods for inducing consumer feedback from consumers of businesses and products. The system gathers feedback from consumers of business by forwarding surveys based on the consumer being in proximity to the business.

### CROSS-REFERENCE TO RELATED APPLICATIONS

This patent claims the benefit of U.S. Patent Application 62/010,362 which was filed on Jun. 10, 2014 and which is incorporated herein by reference.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The disclosure relates to the fields of location-based feedback for consumers experience of products, physical amenities, services, customer service, and so forth. More specifically the present disclosure relates to a method of inducing consumers to provide feedback and providing business with targeted controlling of the inducing of customer feedback in a mobile platform.

2. Description of the Prior Art

Presently, many companies request feedback about their services or their products through e-mail, mail, telephonic information that was acquired during the course of purchasing or registering to use said services or products. For example, some airlines request feedback on flights via e-mail to customers who have recently flown and used their e-mail as a mechanism to receive electronic information about flight details and airline tickets. The airline has access to the information that the consumer provided as a way of requesting the feedback. Similarly, hotel chains like Hyatt or Marriot request similar feedback on recent stays. However, this feedback often comes days after the trip or stay and the consumers may not have any incentive to respond.

Other platforms use a ‘secret shopper’ method to pay customers to secretly visit a business and provide a review of the business in exchange for money, entrance to the venue (such as theme park), or a free meal at a restaurant. However, these platforms usually request a serious time commitment and can be costly undertakings.

Other platforms that exist for giving feedback include rankings or user-generated, such as YELP. These platforms work based on users providing information on overall business and may be limited to certain demographic groups. The feedback may be inconsistent, non-specific (product/service), non-standardized, and in some cases not available (deleted) due to internal vetting policies. On the flip side, the feedback may be gamed to reflect an overly positive or negative image, which may or may not be helpful to those making business decisions based off these kinds of feedback.

### SUMMARY OF THE INVENTION

It is recognized a platform is needed to promote consumer feedback, where the consumer is compensated, and the business owner has the ability to view in real-time or later the demographics of consumers visiting their particular business. The system and methods described herein provide a mobile platform to encourage consumers to visit businesses in the system, check-in, and receive opportunities to be compensated for the consumers' feedback.

In certain embodiments, the consumer registers their demographic information through a mobile/web-based interface device that stores associated demographic information along with an associated username. Additionally the information can be gathered from their social network profile. Consumers and businesses may also access their accounts from non-mobile computing devices that are linked to the consumer feedback system.

In certain embodiments, the business owner registers information about the business such as location, hours, and so forth. The business owner may also register contact information including e-mail address, phone number, and social media information.

In certain aspects, a consumer may utilize an application stored on a mobile computing device that is connected to a network. The consumer may utilize the application to indicate to a business owner that they have arrived to conduct business. The application then sends semi-anonymous data to an application running on the business' computing device such as a computer or mobile device, such as a smart phone.

In some embodiments the business owner receives a notification when a consumer checks in, which may be manual through an active step or passive through an automatic detection step. This notification may be passed along immediately or time-delayed. In some instances, consumers may determine how quickly a business owner is alerted to when the consumers checks in or rather makes a notification that they are on the premises to conduct business.

Business may also view in real time, the type and number of consumers who have checked in at their store. The business owner may then choose to send surveys to one or more of the consumers that have checked in. Consumers, via an application on a mobile device or other computing device or through a browser, may receive the surveys and choose whether or not to complete the survey. Upon completing a survey, the consumer receives monetary compensation (or points towards products/services). If the consumer does not fill out a survey within a specified time frame, the business may be notified that the consumer opted to not respond and the business would not be charged a fee. The consumer would also not be compensated if they did not fill the survey out in time, if the business had enabled the feature which puts a limit on the amount of time in which they will accept a response. In some cases the ability to respond to the particular survey is removed altogether.

In certain aspects, the systems and methods described herein include a network server comprising storage memory and processing circuitry. The processing circuitry is configured to retrieve consumer input data from the storage memory, receive location information from a personal computing device, determine a consumer is associated with the personal computing device, send notifications to business devices, retrieve responses to requests for information from the consumer, and transact monetary exchanges.

In certain embodiments, an app (or application) is pre-installed on a consumer's mobile device and in some instances automatically detects when a consumer carrying the mobile device with the app on it has entered a place for business. The app, utilizing the mobile device's hardware, such as GPS and wireless antennas, may then confirm if the business is part of the consumer's feedback system. The consumer may then be prompted to ‘check-in’ or may ignore the prompt.

In certain embodiments, an application can let the consumer know whether the present business is part of the system and if not, the consumer can send a request to the system that the business be added. Such notifications may then be supplied to non-participating businesses who may or may not choose to participate.

In certain embodiments of a consumer feedback system, the system includes storage memory and processing circuitry. The processing circuitry is configured to retrieve consumer input data from the storage memory, receive location-based information for consumers and store it in memory, and analyze the location with the consumer input data and location information. In addition, the system receives notification information and confirms the notification information is based on location. The system sends notification information to a business associated with a business at the confirmed location.

In certain embodiments, the business may prompt a consumer to provide feedback through the system by replying to a survey. In certain embodiments, the location-based information for the consumer is received from two distinct locations.

In certain embodiments, the prompt includes compensation.

In certain embodiments of a method of a consumer feedback system to provide feedback to businesses from consumers, a central station enables communication between a plurality of businesses and a plurality of consumers, wherein the central station has a consumer information database and a business information database. Consumers have the ability to check in when at a business location. Businesses are notify when a consumer has checked in to the location of the business. The system has the ability to send out surveys for the business wherein the business obtains feedback from consumers.

In certain embodiments, the system takes credit from business when surveys are sent and charges the business only when a survey is returned. In certain embodiments, the consumer is compensated for returning the survey wherein the compensation is not tied to the business. In certain embodiments, the compensation is a monetary award. In certain embodiments, the compensation is credit for a non-monetary award.

In certain embodiments, the two part check in includes input of a code accessible in the business. In certain embodiments, the code is inputted by scanning into the system. In certain embodiments, the code is typed into the system. In certain embodiments, the one of the two part check in includes gathering locations from a location generating device.

In certain embodiments, the system provides the ability for a second business to use the location of a first business and grant access to the data related to the surveys associated with checking in during the time the second business is at the location of the first business.

In certain embodiments, the second business is a vendor at the first business.

In certain embodiments, the business can forward information when the consumer checks in. In certain embodiments, the system provides the ability for the consumer to store information on businesses. In certain embodiments, the system provides access to businesses and consumers to each individual account.

These and other embodiments are described in more detail herein.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C is a flow chart depicting a system in which a business and a consumer interact with a consumer feedback management application; and

FIG. 2 is a schematic showing a consumer feedback management system.

### DETAILED DESCRIPTION OF THE PREFERRED EMBODIMENT

Consumers have been frequenting service providers such as hotels, restaurants, airlines, grocery stores, mercantile stores, hardware stores, and so forth since the advent of each. Additionally, such consumers have formed opinions of the various service providers.

The service providers have tried to obtain information regarding these consumer opinions to increase sales and consumer experience to create brand loyalty and reduce liabilities. Obtaining feedback and demographic information with location-based sensing devices that can transmit said information to service providers in real-time provides for increased responsiveness to said feedback.

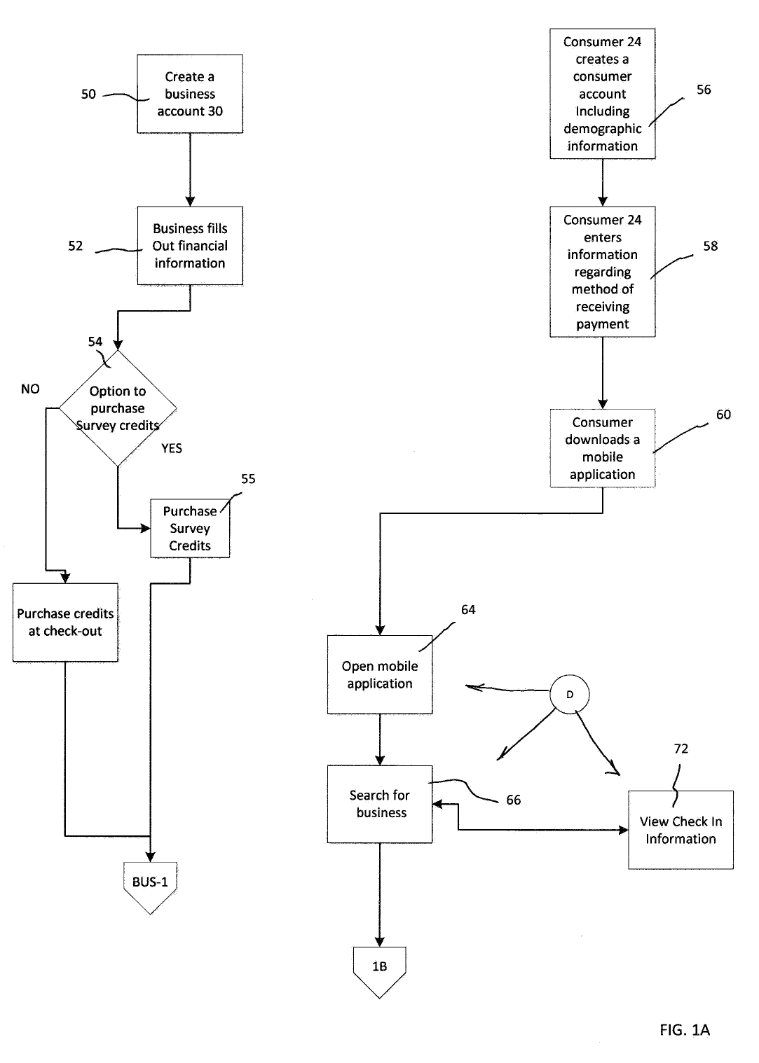

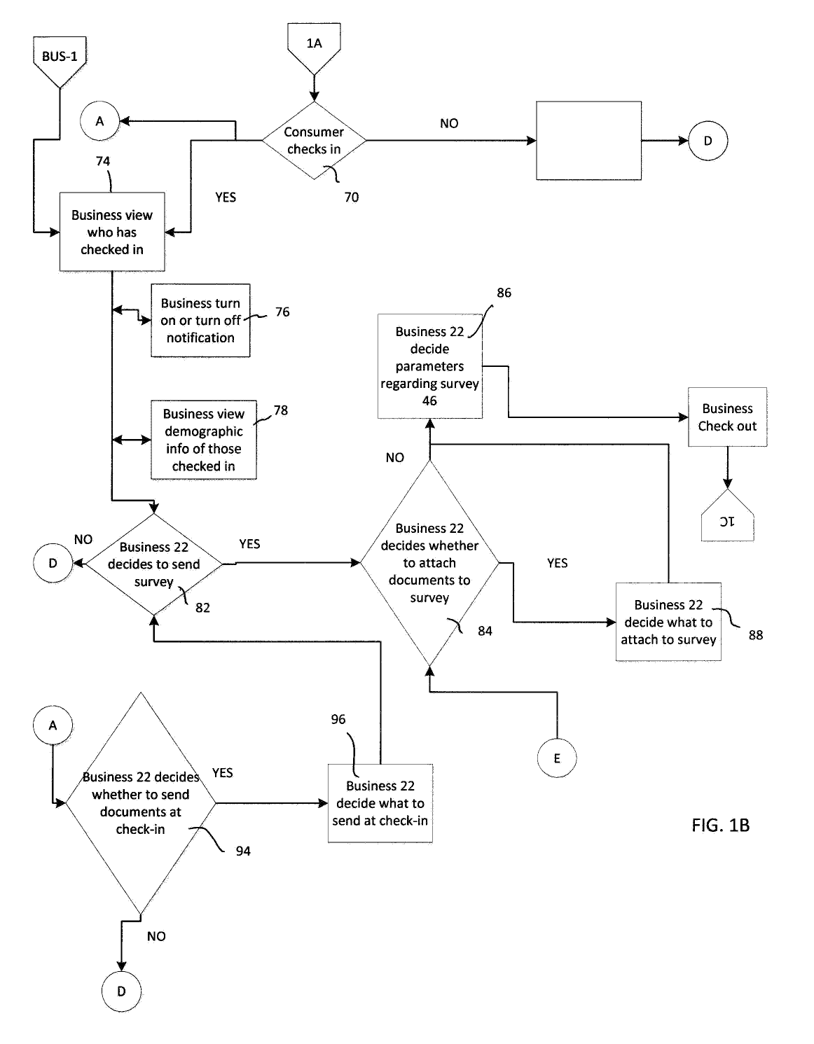

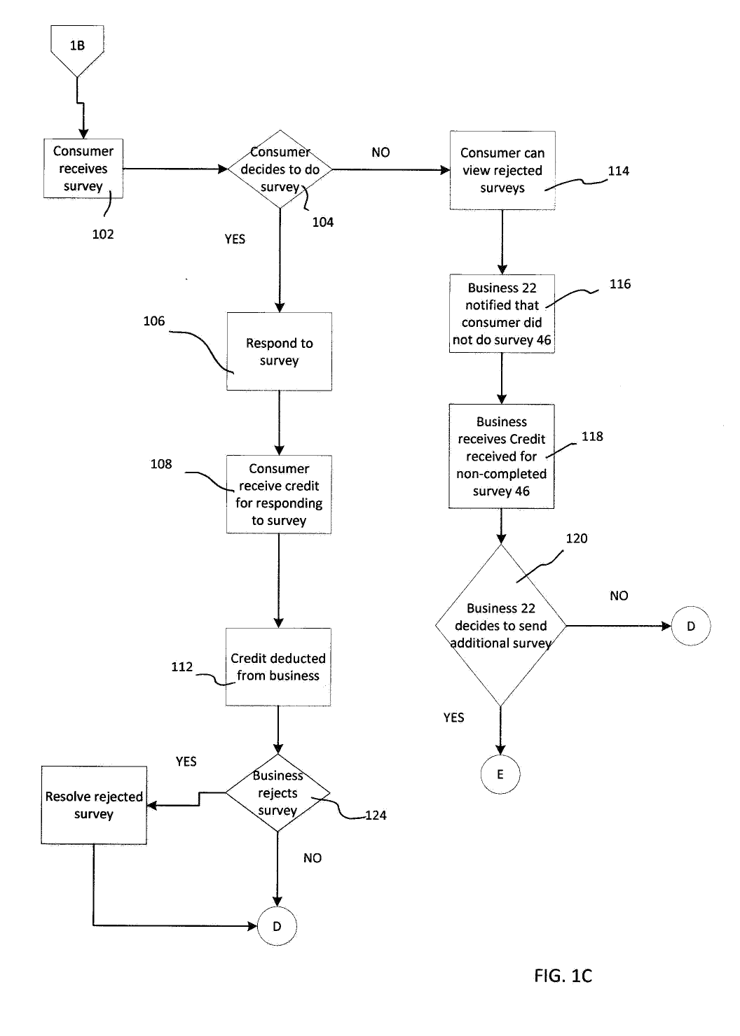

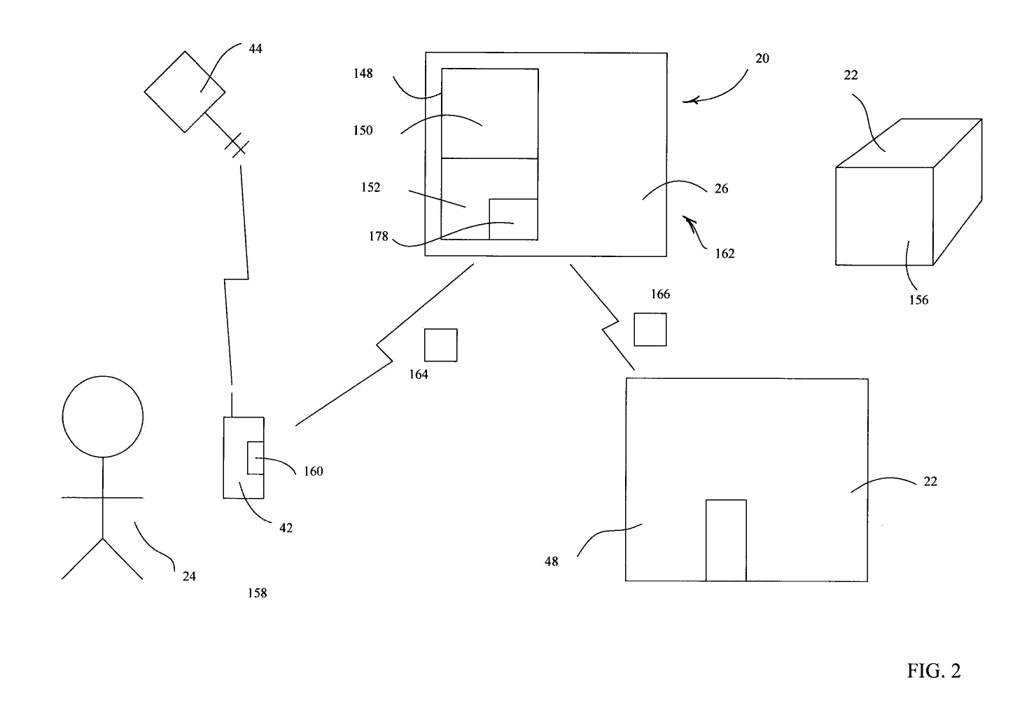

Referring to FIG. 1A, a flow chart depicting a system 20 of a business 22 and a consumer 24 interacting with a consumer feedback management application 26 is shown. A business 22 creates a business account 30 on the consumer feedback management application 26 as represented by block 50. The information on the business account 30 can include demographic information, such as: business name, location, website URL, hours of operation, etc. In addition the business 22 fills out financial information for payments made within the system 20 as represented by block 52. FIG. 2 shows a schematic showing the consumer feedback management system 20.

The business 22 has the option to purchase survey credits in advance, or wait to checkout prior to sending surveys as represented by decision 54. The business has the option to pre-purchase credits or wait until they checkout to purchase; it is contemplated in an embodiment that there are price breaks and benefits to purchase in advance.

A consumer 24 creates a consumer account 34 on the consumer feedback management application 26 as represented by block 56. The information that the consumer 24 can include on the consumer account 34 are demographic information, such as: age, gender, marital status, residence, hobbies, etc. In an embodiment, the consumer feedback management application 26 requires a minimum amount of information to set-up an account. As will become more apparent below, the consumer 24 has a benefit for filling in the demographic as completely as possible. As part of setting up the consumer account 34, the consumer 24 creates a (customer or consumer) username 36 to keep their identity private.

The consumer 24 enters information regarding where the consumer 24 wants to receive payment as represented by block 58. In an embodiment, the consumer 24 is limited to entering bank account information. In another embodiment, the consumer 24 has multiple options including bank accounts, bitcoin account, rechargeable debit card, and online payment system through an internet payment company. This account is where the consumer 24 is compensated for completion of the survey as explained below.

One purpose of the customer feedback management system 20 is to maximize the number of consumers 24 actually becoming customers. In that the system 20 gives the business 22 the option of surveying a consumer regardless if a purchase is made, the term consumer is used in contrast to customer.

The consumer 24 downloads a mobile application 40 associated with the customer feedback management application 26 to a smart device 42 such as a smart phone, tablet, or any device that allows you to download an application as represented by block 60. The information that resides on the mobile application 40 can be limited to the username 36. The other demographic information can be retained in a consumer information database 150 of the customer feedback management system 20. The customer information database includes each consumer's 24 individual customer account 34 and username 36. In one embodiment, the consumer information database 150 of the customer feedback management system 20 is located in a server farm or in the internet cloud as seen in FIG. 2.

Still referring to FIG. 1A, the consumer 24 during the normal day either visits a location 44 of a business 22 or is in proximity to a business 22. As contemplated below, the business 22 may not be a subscriber to the customer feedback management system 20. The consumer 24 opens the mobile application 40 as represented by block 64.

It is recognized that the customer feedback management application 26 could have an option to notify the consumer 24 that the consumer 24 is approaching a business 22 that is part of the system 20. For example, if the consumer so desires, the consumer 24 can enable the function to send a push notification to the consumer's device notifying the consumer that a participating business is near and asks if they wish to check in. The consumer will have the option to enable or disable this function.

With the mobile application 40 the consumer 24 searches for the business name as represented by block 66 within the application 40. The mobile application 40 can use a GPS 44 driven feature to search for businesses 22 that are in proximity such as seen in FIG. 2. In certain embodiments, the business 22 can include businesses 22 that are not a user of the customer feedback management application 26. It is contemplated in an embodiment that the location 48 of the business 22 is retained in a business information database 152, also referred to as a service provider database; the location 48 of the business 22 is not going to move so there is no need to pull or update the GPS 44 information (i.e., the location of the business) as contemplated for consumers 24 in certain embodiments.

Furthermore one business 22 can have multiple locations 156 and the locations can be tied together in various ways or be totally separate entities. The business 22 can have more than one location but the particular location 48 in question will be displayed when the consumer 24 tries to check in. The business 22 will then have access to multiple accounts or the business 22 will have the option to keep the accounts separate and let the management of each location 156 manage its own account or the business 22 can merge all of the business accounts 30 and view the information that they want via a drop down/selection menu. For example, if a business had a single location in each of the New England states, the business can select which location the business 22 wishes to view via a drop down menu or the business 22 can select the “view all” option and see all of them in one screen or file. Furthermore, the business 22 can also create a survey for one location and then save it, create another survey 46 for another location, save it, and then create another survey 46 for another location and then check out only once (instead of 2, 3, 4, or 5 more times). There will be many options for the business 22 regarding survey 46. If a business 22 has more than one (1) location and the business 22 wishes to send a different survey 46 to each location 156, the business 22 will have the option to create the survey 46 and then create another survey 46 for a different location 156. The checkout process would only happen once because the business 46 can save their work and checkout when they are ready.

If the business 22 is a member of the customer feedback management application 26, the consumer 24 can click the option to “check-in” to the business 22 as represented by decision diamond 70 in FIG. 1B; thus indicating that the consumer 24 is visiting the location 48 of the business 22.

Referring to FIG. 1A, after the business 22 has established a business account 30, the business 22 is ready for the consumer 24 to “check-in.” The business 22 waits until a consumer checks-in and then the business can view as represented by block 74 in FIG. 1B.

In one embodiment, when activated, the processing circuitry 160 associated with the mobile application 40 on the smart device 42 determines the location 158 of a consumer 24, determines if a business 22 is using the customer feedback management system 20 is in the vicinity and prompts the consumer 24 with a message. For example, a consumer 24 carrying a smartphone device 42 enters a business 22, such as a restaurant, identified in the business information database/service provider database 152 associated with the customer feedback management system 20. The entering of the business 22 results in a change in the display screen of the smartphone 42 to say, “Would you like to Check in?” and “Thank you for checking in.”

Other examples include the portal processing circuitry 160 or user processing circuitry to notify the consumer 24 by email, a notification at a user portal, text message, cellular telephone system, and/or a social media site (Twitter, Facebook, etc.). In additional embodiments, the communication between the processing circuitry 160 related to the location 158 and the business 22, the service provider, may provide discounts, special events, welcoming messages, upgrades, personalized surveys, and so forth as discussed below.

The consumer 24 can view “check-in” information within the mobile application 40 of the customer feedback management application 26 as represented by block 72 as FIG. 1A. When a consumer 24 checks into their consumer account 33, the consumer can see various items that can include a history of their “check-ins.” The “check-in” information can also include business demographics, such as: business name, location, website URL, hours of operation, etc.

In addition as explained in more detail below, the consumer 24 can view their “check-in” information also at later dates. In addition to the above business demographics, the consumer information allows the consumer 24 the ability to keep track of where the consumer 24 is doing business including date and time of check in and can have access to the data concerning their purchases. In addition, the customer 24 can make notes related to their check in so they can remember things they viewed/purchased or witnessed (such as staff behaviors, etc.), or if there was a sale going on and they wanted to remember the store or the item they viewed.

In contrast to conventional systems where it is known for a consumer 24 to check in, in this system 20 the business 22 can view who has performed a “check-in” at their business location, in real time as represented by block 74. When a consumer 24 checks in, that information automatically generates information in the business' account. The business 22 has the option to receive a notification when someone checks into their business 22, and the check in information is what they would be viewing. For example: Joe checks into the restaurant. As soon as he does, the business logs into their business account 30 and can “view” (in real time) information pertaining to Joe's check in.

When a consumer 24 checks in to the business 22, the business 22 if they are looking at their business account 30 or if the business 22 has the “notification” function turned on, the business 22 can see who is checking into their business 22. It will happen as fast as sending an email and waiting for the recipient to receive it. The information that the business 22 can receive includes the consumer's username, date/time of check in, location (if applicable), and demographic information.

When a consumer 24 checks in, there is a time-stamp associated with the check in so that the business 22 knows when it occurred. When a consumer 24 creates an account 34, there will be an option to alert the business 22 when the consumer 24 is performing their check in. For example: when consumer 24 Joe create the consumer account 34, Joe selects an option of when the business 22 will be notified of Joe's check in, such as “immediately, “30 minutes,” “2 hours” etc. (these are merely examples to help you understand the time). This way, a consumer 24 can decide if the consumer 24 would like the business 22 to learn of the consumer 24 check-in immediately or after the consumer 24 has departed the business 22; this may help with privacy concerns.

While the system 20 can be tailored, it is contemplated that in an embodiment that a consumer 24 is defined as “new” if the consumer 24 has not “check-in” in the past 12 hours. In this embodiment, there will be a time limit on the consumer's account that will not allow them to check in to the same location within a 12-hour period.

The business 22 has the option of turning on or turning off notification as represented by block 76 as seen in FIG. 1B. In addition, the business 22 can view demographic information for all consumers who have performed a “check-in” recently or in the past as represented by block 78.

The business 22 can decide to send a survey 46 as represented by decision diamond 82. The business 22 can sort and select consumers 24 to whom the business 22 wishes to send a survey to, based on their demographic information. The business 22 may choose to select the function that automatically sends a survey 46 based on rules that have been previously developed. The operator of the system 20 can determine what features, such as the above for which the business will be charged additional cost.

The customer feedback management system 26 can provide the business 22 several options related to the survey 46. For example the customer feedback management system 26 can give the business 22 the option of a time limit for accepting responses to the survey 46 as represented by block 86. For example, the business 22 can send out 20 surveys but only wish to accept responses that are received within a 48-hour time period. The consumer 24 is informed of this time limit when the consumer 24 receives the survey 46 in their consumer account in certain embodiments. All surveys 46 not responded to after the 48-hour time period will be de-activated and the consumer 24 will no longer be able to respond to the survey 46. It is recognized that the system 20 may charge an additional fee to the business 24 for this option.

It is contemplated in an embodiment that the consumer 24 will not be aware that this function has been enabled. The system 20 in this embodiment wants the consumer 24 to respond normally and not be aware that the business 22 has paid for early responses only. If a consumer 24 knows there is a time limit placed on a survey 46 (meaning after a specified amount of time, the business 24 won't accept answers), the consumer 24 might respond more quickly but with less effort and thus provide a lower quality response. Therefore, the time limits or survey constraints (if any) will not be shared with the consumers 24.

In an embodiment, the business 22 can select an exact number of consumers 24 to whom the business 22 wishes to send a survey 46 or the business 22 can select that the survey be sent to more consumers 24 that meet the criteria but limit the number to a specific number of surveys that will be accepted from consumers 24. For example, if the business 22 wants to receive 50 survey 46 responses, the system 20 sends out 100 surveys for the business 22 but only accepts 50 responses. After the 50^{th} response is received, the business will have the option to keep the survey open or close the survey and all remaining surveys will expire. This option will not inform the consumer that there is a “time limit” associated because the system 20 does not want consumers 24 to rush their responses. In certain embodiments, the business 22 will be notified when the survey limit has been reached and the business 22 will be asked if the business 22 wishes to keep link open for additional surveys 46. The link will be disabled until the business responds to the question of whether or not to continue receiving responses from consumers 24.

For example: the business 22 can select 100 consumers 24 to send their survey 46 to but only wish to receive a response from 50 consumers 24. The customer feedback management application 26 will only allow the first 50 consumers 24 to respond; after the first 50 consumers 24 have responded, the option to respond to the survey is turned off for the consumer 24 and a small notification is displayed informing the consumer 24 why the option is no longer valid. This example is represented by block 86. The business 22 can opt to receive a specified number of surveys 46 after the business 22 mark has been reached; this is an option the business 22 would have to select. It is recognized that the system 20 may charge an additional fee to the business 24 for this option.

Once the business 22 has selected the consumers 24 to whom the business 22 wish to send a survey 46, the business 22 is directed to the survey wizard, where the business 22 will create a survey 46; this survey 46 will be the same for all selected consumers 24.

The business 22 can select from a list of template questions or create their own questions to send to the consumer 24. The business 22 can repeat the process if the business 22 desires to send a different survey 46.

The business 22 has the option to attach an item, such as: flyers, coupons, promotions, etc. as represented by decision diamond 84. In one embodiment, the business 22 is charged an additional fee for the attached item.

The customer feedback management application 26 can also have the option of giving the business 22 the option of sending promotional items to consumers 24 immediately as the consumer 24 “checks in” to the location of the business 22 as represented by decision diamond 94 as seen in FIG. 1B. The promotional item could be a coupon and/or flyer that is day specific. It is recognized that the system 20 may charge an additional fee to the business 24 for this option. In addition, the system 20 may give the consumer 24 the ability to either opt in or opt out of receiving promotional material at “check in” since the receipt of promotional material at “check-in” would not be consider a survey 46.

When the survey 46 creation is completed, the business 22 will be directed to “checkout” or pay for the surveys 46 the business 22 is sending, as well as any additional features that are fee based, such as attachments as represented by block 88.

The businesses 22 must purchase credits for sending surveys 46. The business 22 can purchase credits for surveys 46 in advance or as the business 22 is checking out in the system 20. As indicated above, the business 22 could have purchased credits previously as represented in block 55. In addition, the business 22 could purchase the credits at checkout. The business 22 has a business decision of whether to purchase credits in advance or at the time of checkout. The credits allow the system 20 to credit the business 22 more easily if a response to a survey 46 has not been received. The businesses 22 do not pay if a response to a survey 46 is not received.

The surveys 46 are sent for the business 22 and received by the consumer 24 as represented by block 102 as seen in FIG. 1C. The monetary fee for sending the surveys 46 is held within a “holding” account within the system 20 as represented by block 100. The business 22 only pays for the responses to the surveys 46 received and is credited for surveys not returned.

The business 22 can view all sent surveys within their account of the customer feedback management application 26. Once a survey 46 is sent, the actual survey 46 can be viewed by clicking an option in the business' account 30. This will allow the business 22 to look at previously sent surveys 46. Each survey 46 will also have a link to a report of all consumers to whom they sent a survey.

The consumer 24 is notified that a survey 46 has been requested within their account 34 as represented by block 102. In an embodiment, the consumer 24 can select a method of notification including the ability to turn notifications on or off.

The consumer 24 can view demographic information for the business 22. The consumer 24 can determine if he/she wants to respond to the requested survey 46 as represented by decision diamond 104.

If the consumer 24 chooses “yes” to respond to the survey 46, as represented by the yes path from decision diamond 104, the consumer 24 answers the questions pertaining to the survey 46 and submits their responses as represented by block 106. Once submitted, the consumer 24 cannot make any changes to their submission.

The consumer 24 receives a credit within their account for a monetary amount as represented by block 108. The consumer 24 can withdraw from this account when it reaches a specified amount.

The business 22 has a deduction in the number of credits originally spent to send the surveys as represented by block 112. When a business 22 has sends a survey 46, the business 22 receive a reduction in their credits, meaning the business 22 spent the credits. However The system 20 holds the credit until the consumer completes the survey 46. Once a survey 46 is responded to the system 20 keeps the credit. Therefore, if the surveys 46 are not responded to, the business 22 is given back the credit that were “holding onto”—which establishes a kind of “guarantee” the system 20 only charges for surveys 46 that are responded to. Once the business 22 completes their checkout, their credits are in a “holding period”—which means the business 22 does not have access to the credits; the credits are considered spent. A business 22 cannot send out a survey 46 without having credits. If a survey 46 is not responded to, then the business 22 will be refunded their credit amount and it will be placed back into their business account 30.

If the consumer 24 chooses no, that is not to respond to the survey 46 as represented by the no branch from the decision diamond 104 as seen in FIG. 1C, the consumer 24 selects the option to reject the survey 46. Once selected, the consumer 24 does not have the option to respond to this particular survey 46.

The consumer 24 can view all rejected surveys 46, within their consumer account 34 as represented by block 114. The business 22 demographic information remains visible but the option to respond to any previously-requested surveys is not available. The business 22 is notified within their business account 30 that a survey 46 was rejected as represented by block 116. In an embodiment, the business 22 no longer has the ability to send a survey 46 to this consumer 24, for a specified period of time. For example, the specified period of time could be the shorter of when the customer 24 checks-in again or 48 hours.

The business 22 does not have the option to contact the consumer 24 that rejected the survey 46 about this particular survey rejection.

The business 22 receives a credit refund for the fee originally charged for sending the survey 46 as represented by block 118. As indicated above, the business 22 does not pay for surveys 46 that a consumer has not responded to with the constraints which could be a time element or number of survey, as indicated above.

The business 22 will have the option to send the survey 46 to another consumer 24 as represented by decision diamond 120. The yes branch from decision diamond 120 routes the business 22 to the decision on whether to attach documents to the survey as represented by decision diamond 84. The survey 46 can be similar to the one previously sent or different survey 46 to another consumer 24.

The customer feedback management system 20 can give the businesses 22 the option of rejecting a survey response for various reasons as represented by decision diamond 124. Some examples include the following: incomplete answers; answers that don't make sense; inappropriate language; and false claims. When this occurs, the consumer 24 has the option to dispute the rejection. When a dispute occurs, an arbitrator organization associated with the customer feedback management application 26 becomes the decider and makes the decision if the rejection is legitimate. If the arbitrator organization agrees to the rejection, the consumer 24 will receive a mark on their customer account 34, indicating to businesses 22 that a survey 46 has been rejected in the past. In an embodiment, the mark will be associated with the customer account for the particular customer 24 and is displayed similar to other viewable material related to the consumer 24. The businesses 22 will not be charged for this particular survey 46 result; the business 22 may have the option of sending/receiving another survey 46 to another consumer 24 that has “check-in.” If the arbitrator organization disagrees with the rejection, the consumer 24 will be paid for the consumer 24 survey response.

It is a contemplated that in certain embodiments if a consumer has 3 consecutive months with a rejection each month, the consumer's account will be suspended, the length of time to be determined. In other embodiments, it is contemplated that the mere position of this information will result in businesses 22 declining to select the consumer 24 for future surveys 46.

The system 20 is an iterative process where there may be multiple businesses 22 and multiple consumers 24 using the customer feedback management application 26. After setting up the consumer account 34 and having the application on the smart device 42, the consumer 24 can enter the system 20 at various points including opening the mobile application as represented by block 64; searching for a business 22 as represented by block 66; viewing check in information as represented by block 74; and checking in as represented by decision diamond 70 as seen in FIG. 1B.

Referring to FIG. 2, a schematic showing the customer feedback management system 20 is shown. The customer feedback management application 26 has at least one database 148. For the purpose of discussion, the database 148 has a consumer information database 150 including customer demographics, user names, and individual customer accounts and a business information database/service provider database 152 which includes individual business accounts. Both the consumer 24 and the business 22 can view, sort, and export the data. It is recognized that data can take many forms such as structured data (e.g., date of last purchase), semi-structured data, and unstructured data (e.g., remarks in a survey or notes by a consumer 24 in their own customer account 34).

The system 20 can convey the information between consumers 24 and business 22 in various ways. One representation is that the system 20 has a central station 162 and information such as surveys 46, demographics, and financial is sent to and from the consumer 24 as represented by bolt and block 164 and the business as represented by bolt and block 166. It is recognized that the information may be unique to that consumer 24 or business 22.

It is recognized that the data can be mined for various benefits. In addition it is recognized that in addition to consumers 24 and businesses 22 having different desires in mining the information, within the consumer group and within the business group there will different desires with respect to the mining of the information for specific information and details.

More examples of the data include account statistics from within the customer feedback management application 26. In an embodiment, the consumer 24 can view demographic information of a business 22; history of locations for which the consumer 24 has “Check-in,” and financial history. With respect to financial history, the consumer 24 can view how much money they have earned based on surveys responded to, which business' they responded to, etc.

With respect to consumers that have “check-in,” in an embodiment the information that the business receives regarding “Check-in” is demographic information such as age, gender, marital status, zip code of residence, type of residence (house, condo, apartment), and parental status. No personnel information regarding the consumer 24 is provided.

It is recognized that the business 22 can be accurately representing a second business; for example, a concert venue 176 or location with many vendors, such as a fair or festival. The owner/manager of the venue may choose an option with the business account 30 to allow the contract vendors to access date. This allows the vendors to access the business account 30 to allow them to view data related to “check ins” during a specified period time. As more detail for this example, a business, the ABC festival company, is hosting a festival with five (5) vendors. The ABC festival company chooses the option with their business account 30 to allow for contract vendors to access data. The customer feedback management application 26 asks the ABC festival company to provide details such as specific businesses/vendors that they wish to include and for how long the businesses/vendors wish to allow access.

The businesses/vendor receives a notification within the vendor business account 178 asking for conformation for the businesses/vendor and once approved, the business/vendor will be able to view within their account all “check in” data relating to the ABC festival company business account 30.

Likewise a band or performance artist may wish to access data regarding “check in” data for the date of their concert; the band or performance artist would work together with the venue to be authorized to view data pertaining to the date/time of the consumers 24 “checking in” to the venue 176 via the customer feedback management application 26.

For purposes of this application, a web or mobile browser or mobile application may refer to a software application or display produced by steps performed by processing circuitry for retrieving, presenting, interpreting, and traversing information resources provided by a remote server (e.g., on the internet). At the time of this application, web/mobile browsers may include Chrome, Firefox, Internet Explorer, Opera, and Safari. In addition, a web/mobile application, also referred to as an application or “app” as described herein includes computer software designed to help the user perform specific tasks on a computer or using a mobile device. The application functions are performed by processing circuitry, such as a computer, mobile device, or server, as further described herein. For purposes of the systems and methods described herein, a plug-in may refer to a set of software components that adds specific abilities to a larger software application, such as a web browser or native mobile application. Plug-ins enable customizing the functionality of an application and may be implemented in any suitable architecture, such as Apple iOS, Google Android, Microsoft Windows, Flash player, Java applet, HTML5, or any other commonly used platform known in the art. For purposes of method, a plug-in is a general term which could also be synonymously associated with add-ons, snap-ins, and extensions.

The systems, methods, applications, software code, instructions described herein and elsewhere may be implemented on a cellular network having multiple devices. The cellular network may either be a frequency division multiple access (FDMA) network, a time division multiple access (TDMA) network, and/or a code division multiple access (CDMA) network, or any other suitable form of network implementing any suitable communication protocol and any suitable medium access control protocol. The cellular network may include mobile devices, cell sites, base stations, repeaters, antennas, towers, and the like. The cell network may be a network carrying out a protocol for Global System for Mobile Communications (GSM), General Packet Radio Service (GPRS), any third generation (3G) network, any fourth generation (4G) network, Evolution-Data Optimized (EVDO), ad hoc mesh, Long-Term Evolution (LTE), Worldwide Interoperability for Microwave Access (WiMAX), or other network types.

In one exemplary embodiment described below, a system and method is provided to establish a connection between the business owner and the consumer by accessing consumer's demographic details derived from the consumer/user signing up through the system. This may entail creating a user name and password there are associated with demographic information and rules by which the consumer/user would like to be identified. In some cases, an ability to quickly sign-up with the system may be possible by utilizing an app plug-in that can transfer some of the user profile information from another platform such as Facebook. Once signed-up in the system, the user may then “check in” at a business by scanning a bar code located at any participating business. Alternatively, the app communicating with a wireless device may automatically detect through GPS or Network detection that the user is in the geographic location of the store and send a prompt to check in.

In some instances a multiple alphanumeric code may be required to check-in. For example, a consumer user may arrive at a business, be prompted to check-in via an app downloaded to their mobile device and as part of the check-in process identify and enter into the app (or via the website) the alphanumeric code displayed in the place of business. This may be a two-step process of the customer feedback system identifying via GPS or other wireless that the consumer user's mobile device is in or near the business and then confirm that they have actually entered the store by placing an alphanumeric code inside the store that would require a visual inspection inside the store. In other instances it could be to enter the alphanumeric code, which is then validated by the GPS or wireless transmission. One step processes of entering the alphanumeric code or identifying via GPS or wireless methodologies are also contemplated.

A business owner may communicate (in the form of a “survey”) with the consumer each time they “check in” to their business location and enable the consumer to be monetarily compensated for their responses/opinions to the survey or questionnaire This compensation for feedback methodology is used to increase the ROI for the survey industry by being able to target specific individuals who are visiting the business' location at a certain time of day, day of the week, or during promotions and that may also fit a particular demographic profile the business is hoping to ascertain feedback that may assist in providing better services/products for those particular consumers. Again the methodology is enabled by those consumers who are willing to respond to a “survey” in exchange for compensation that allows the business owner to view who is visiting their business location and allows the consumer to keep track of where they are doing business. As mentioned a “check-in” may also be initiated through location-based GPS or similar technology. Another form of checking-in may occur through a wireless network. For example, a business may have a wireless signal that transmits a pinging code that the application can detect and cause the application to display a message.

The customer feedback system business will be built around a “survey” model whereby consumers will establish an account on the customer feedback system website or through the mobile application. In some versions and in order to create an account, the consumer must answer a series of demographic questions pertaining to their life, such as: income, residency, family size, marital status, interests, purchasing habits, etc. This process is required for anyone to participate in the services of the customer feedback system. The consumer may also be required to complete a series of additional steps to complete their setup process:
1. Connect their customer feedback system account with their respective social network accounts, such as: Facebook, Foursquare, etc.
2. Customer feedback system will create a social network application to help join the various social network accounts and their customer feedback system account
3. Add and verify their bank account information for the purpose of withdrawing funds earned through customer feedback system
4. (optional) Create a screen name for their account so that they may remain anonymous within the customer feedback system online community

In some versions a consumer user may use an already established social media platform like Twitter or Facebook, to ‘check in’ to the customer feedback system. By using the social media credentials, the user may not create a specific consumer user name or profile for the Customer Feedback system and profile information associated with the social media platform may then be accessible to the business users who want to engage specific customers for feedback and use the incentive methods described herein to do so.

In many versions a consumer creates an account and associated username with the Customer Feedback System that requires certain demographic information such as gender, age, place of residence, education, and so forth. Once the consumer creates the account and a specific consumer username they will then have the ability to ‘check in’ at businesses and benefit from using the Customer Feedback system. These consumer users can receive monetary awards for completing surveys, which may require the consumer user to supply banking account information for the monetary awards to be deposited into. As mentioned, consumer users may download an app to a mobile device or use the Customer Feedback System through a web browser to complete surveys that are offered to them, receive special offers for checking in, rate businesses, and otherwise engage with the Customer Feedback

System. This can be accomplished through any computing device that is connected to the World Wide Web.

Consumer users may also link other social media accounts such as Foursquare and Facebook credentials to their already generated Customer Feedback System account and user information. Instead of checking in using the Customer Feedback System Consumer username and/or password, the consumer user may use the login credentials or username of their linked social media account such as Facebook, Foursquare, Twitter and so forth.

Business owners will also be required to establish an account with the customer feedback system in order to participate in any services. Business owners will have a similar sign up process but it will be focused more on their business information, such as: location, revenue dollars, industry, hours of operation, etc. Once they have established an account, they will also be required to do a series of additional steps to complete their setup process:
1. Create a profile within the customer feedback system with information pertaining to the business, hours, promotions, etc.
2. The reason a profile is required is because consumers need to be able to establish a “check in” connection with the business location
3. Add and verify the business billing information for the purpose of making payments to the customer feedback system for services rendered

At this point we can assume both the business owner and the consumer have established accounts through the customer feedback system and all account information, including billing, has been verified and approved.

Each time a consumer visits a participating customer feedback system business location, the consumer has the option of (1) “checking-in” their location via an application that utilizes wireless methods (wifi, cellular, etc) or (2) scanning a unique bar code presented by the business through the customer feedback system mobile application. Either process will produce the same result as the consumer has already established an account through customer feedback system. Once that “check-in” or scan has taken place, customer feedback system will process that information, interpret it, reformat it, and finally send it to the business owner, within their online customer feedback system account. At this stage, the business owner can opt to receive a notification that a consumer has “checked-in” to their location or they can simply visit their account at their leisure to learn of new consumers visiting their location. This information will be displayed in real time.

When the business owner opens their account page they will see a list of those consumers that have either “checked-in” or scanned a bar code at their location. The information presented to the business owner will be all of the demographic information filled out by the consumer when they created their account on customer feedback system. The business owner, for the first time, will be able to view (in real time) who is visiting their business location and learn all about their spending habits, lifestyle, etc., without ever having to interact with them or send them a standard email or mail survey. The only information they will not be able to view is personal information, such as: name, address, email address, or any other personal contact information.

At the same time that the business owner is viewing the consumer's information, the consumer can log into their account and view a list of locations that they have visited via their “check-in” or bar code scans. For the first time, consumers can keep track of where they are shopping or doing business. They will be presented with a list of business information for each business listed (the same information that was filled out when the business owner signed up for their account), such as: address, contact information, website, email, hours of operation, etc. The consumer may also take notes and pictures that may be posted to an online board and/or sent directly to the business for other consumer users and of course the business to benefit from such information.

The business owner now has the option to “survey” the consumer connected with the “check in” or scan; for a fee. They do this by selecting the consumer in their list of “who has checked in” and clicking the respective button that allows them to “survey.” The business owner will have the ability to sort their visiting consumers based on any of the demographic information submitted by the consumer. For example, if the business owner wishes to “survey” all visitors from a specific date, or anyone who is between the ages of 25-30, or anyone who is married, etc., the business owner will have the option to choose one consumer or multiple consumers based on their desired criteria. Once the business owner clicks the respective button to send a “survey,” they have the option to choose from a series of template “survey” questions or create their own. They will also have the option to send a printable coupon, an advertisement, an invitation, a menu description, product information, and so forth along with the “survey” (for an additional fee). Once they are satisfied with the “survey,” they can click send and the “survey” will be sent to the consumer's account for review and completion. All “surveys” that are sent will now be listed in a separate table/page within the business owner's account. This allows the business owner to keep track of those surveys that have been sent, who they sent them to, when they sent them, if they have responded, etc. In an embodiment, the system 20 assess a fee for a survey 46 of between $0.05 and $5 per survey 46.

Coupons, advertisements, invitations, menu descriptions, product information, and so forth sent along with surveys may also cost the business user between $0.05 and $5 per incident. The benefit is the business user can use these additional enticements on a target market to see what kind of response it generates and modify future promotions accordingly.

The consumer can log into their account to view incoming “surveys” or they can choose an option to be notified when a new “survey” has been sent to them. The consumer has the option to respond or deny the “survey.” If they deny the “survey,” the business owner will receive (1) a credit for that survey sent, (2) a notification stating that consumer denied the option to respond and (3) the option to send the same “survey” to another consumer. If the consumer accepts and responds to the “survey” they will receive a monetary credit for their submission, with the option to withdraw the money into their bank account once it reaches an established amount. Before their money is available to withdraw, the business owner must first approve that the responses submitted were coherent and acceptable. Both the business owner and the consumer can dispute the results and customer feedback system will make the final decision. However, the business owner has a limited amount of time to approve/disapprove the “survey.” If they do nothing in the time frame, the “survey” will automatically be approved. The consumer will be able to view all of those “survey's” that they have either denied, responded to and have received approval and responded to and have not received approval through a separate table/page within their account. The business owner also has the option to respond to the “survey” to say thank you or comment on the responses sent by the consumer; there is an added fee associated with this option and all responses will be approved by customer feedback system prior to sending to the consumer, to avoid promotional advertising.

The customer feedback system 20 will allow business owners 22 and consumers 24 to communicate without ever meeting face to face or without the business owner 22 ever having to send out a blind survey in the hopes the business 22 receive the survey back. Through the customer feedback system 20, the business owners 22 are only paying for those “surveys”46 for which responses are received, but the business 22 are able to view the “check-in” information for anyone who uses the customer feedback system service 22 and “checks-in” to the location 48 of the business 22, which allows them to constantly monitor who is visiting the location 48 of the business 22 and when. It is recognized in most embodiments, the business 22 will be charged a fee associated with solely viewing the information and not actively sending out any “surveys” 46.

In addition, the consumers 24 are also now able to keep track of their data concerned with purchases, dining out, shopping etc. Any business location 156 that the consumer 24 visits and “checks in” with, through the customer feedback system 26 through one of the various methods including GPS or through a bar code scan, will be listed within the customer account 34 and that information can be viewed, printed, exported, etc. The consumer 24 can also log into the customer account 34 and place notes under their “check-in” location, so they will be able to remember what they purchased, how much, why they purchased it, who they were with, etc. This information is private and only viewable to the consumer 24 who owns the specific customer account 34. This information can also help the consumer 24 answer questions of the survey 46, if needed.

For example, Joe checks into Bills BBQ Restaurant and LOVES the BBQ ribs and wants to remember that during his vacation, he not only ate at this restaurant but loved the ribs; so he makes a note on his check in so he can view it later. When Joe is sent a survey from his check in, the system 20 will alert Joe that he made a note on his check in and he can view it prior to responding to the survey. This may or may not help Joe answer the questions in the survey.

While several embodiments have been described that are exemplary of the present system and methods, one skilled in the art will recognize additional embodiments within the spirit and scope of the systems and methods described herein. Modification and variation can be made to the disclosed embodiments without departing from the scope of the disclosure. Those skilled in the art will appreciate that the applications of the embodiments disclosed herein are varied. Accordingly, additions and modifications can be made without departing from the principles of the disclosure. In this regard, it is intended that such changes would still fall within the scope of the disclosure. Therefore, this disclosure is not limited to particular embodiments, but is intended to cover modifications within the spirit and scope of the disclosure.

It is recognized that in certain embodiments, certain blocks and decisions are not offered or necessary. For example, in certain embodiments the feature of giving the business the option to reject a survey 46 is not offered and therefore decision diamond 124 would not be included in the system 20.

It is recognized that the customer feedback management system 20 can have additional features. One such option is for a business 22 having the capability to respond to the surveys 46 if desired. In an embodiment, the business 22 would be charged an additional fee for this option. The response will be screened by the system 20 to ensure that no personal information is shared such as names, phone numbers, and email addresses within surveys or responses. The business has the option to send an attachment for an additional fee.

It is recognized that in an embodiment of the customer feedback management system 20, the business 22 can view the “check in” data related to the consumers 24 who have visited the location 48 of the business 22 for free as long as the business 22 sends a specific number of surveys 46 per months. If the business opts to not send surveys, the business 22 will be required to pay a small fee per month to view the data. It is contemplated in an embodiment, the cost of viewing data is less than sending a specific number of surveys.

When the consumers 24 respond to surveys 46, the consumer account 36 of the specific consumer 24 receive an increase in the number of surveys 46 to which the consumer 24 has responded. When a business 22 is determining to whom to send surveys 46, the system 20 allows the business 22 to see this number as part of the demographics of a consumer. The number is part of information regarding the frequency of consumer's responses)

In an embodiment of the customer feedback management system 20, the business owners 22 can review the responses of the surveys 46. The business owners 22 can rate the responses received. For example, the business owners 22 can rate the survey either a 1, 2, or 3. This number will be displayed next to the consumer's user name in their account, which will be visible to businesses to help the businesses 22 determine to whom to send surveys (based on the rating number indicating the quality of their surveys, as determined by businesses).

As stated above, consumers 24 can withdraw their earnings after a specific amount is earned within their account from responding to surveys. It is recognized that the system 20 may also partner with outside vendors, to allow the consumers 24 to spend the funds within their account in partner online stores, such as Amazon, Apple, Staples, E-Bay, and Barnes & Noble.

As stated above, the consumers 24 can choose various locations to deposit the earnings including their bank account, PayPal, or another online payment system.

It is recognized that there could be an option for a consumer 24 to donate their earned funds to a charitable organization, which will be listed and linked within the account in the system 20. Each time a consumer 24 donates their funds, the amount donated will also be displayed next to the consumer's user name within their account in the system 20. This may also help businesses 22 determine which consumers 24 to send surveys to. The consumers 24 may also select an option within their account that allows them to display that all funds earned within the customer feedback management system 20 will be donated; thus indicating to businesses that if the business 22 sends a survey to this consumer 24, they will donate the funds.

It is recognized that the customer feedback management system 20 can have a feature where if a business 22 is not listed when a consumer 24 attempts to “check in,” the consumer 24 will still be able to check into this location. The system 20 will utilize a service that takes the GPS information of the consumer 24. This service will search for businesses in the area and identify those that currently have a business account 30 in the business information database/service provider database 152. The information collected from this “check in” will be utilized by the system 20 to allow the system to target businesses 22 to add to the system 20. The business is shown the amount of visits they receive.

It is recognized that in certain embodiments, an application is pre-installed on a consumer's mobile device and in some instances automatically detect when a consumer carrying the mobile device with the app on it has entered a place for business. The app, utilizing the mobile device's hardware, such as GPS and Wireless antennas, may then confirm if the business is part of the customer feedback system. The consumer may then be prompted to ‘check-in’ or may ignore the prompt.

What is claimed is:

1. A customer feedback system, comprising:
storage memory; and
processing circuitry configured to:
retrieve consumer input data from the storage memory;
receive location-based information for a consumer and store in memory;
analyze the location with the consumer input data and location information;
receive notification information and confirm the notification information is based on location; and
send notification information to a business associated with a business at the confirmed location.

2. The system of claim 1, wherein the business may prompt induce a consumer to provide feedback through the system by replying to a survey.

3. The system of claim 2 wherein the location-based information for the consumer is received from two distinction locations.

4. The system of claim 2 wherein the prompt induce includes compensation.

5. A method of a customer feedback system to provide feedback to business from consumers comprising:
providing a central station wherein the central station enables communication between a plurality of business and a plurality of consumers, wherein the central station has a consumer information database and a business information database;
providing the ability for a consumer to check in when at a business location;
notifying the business when a consumer has checked in to the location of the business; and
providing the ability to send out surveys for the business wherein the business obtains feedback from consumers.

6. A method of claim 5 furthermore taking credit from the business when surveys are sent and charging the business only when a survey is returned.

7. A method of claim 6 wherein compensating consumers for returning the survey wherein the compensation not tied to the business.

8. A method of claim 7 wherein the compensation is a monetary award.

9. A method of claim 7 wherein the compensation is credit for a non-monetary award.

10. A method of claim 5 wherein the check in method is a two part system.

11. A method of claim 10 wherein the two part check in includes input of a code accessible in the business.

12. A method of claim 11 wherein the code is inputted by scanning into the system.

13. A method of claim 11 wherein the code is typed into the system.

14. A method of claim 10 wherein one of the two part check in includes gathering locations from a location generating device.

15. A method of claim 5 wherein the system provides the ability for a second business to use the location of a first business and grant access to the data related to the surveys associated with checking in during the time the second business is at the location of the first business.

16. A method of claim 15 wherein the second business is a vendor at the first business.

17. A method of claim 5 wherein the business can forward information when the consumer checks in.

18. A method of claim 5 wherein the system provides the ability for the consumer to store information on businesses.

19. A method of claim 5 wherein the system provides access to businesses and consumers to each individual account.
